(19) United States
(12) Patent Application Publication
(10) Pub. No.: US 2015/0266154 A1
(43) Pub. Date: Sep. 24, 2015

(54) Method for sharpening cutting edges

(71) Applicants: Raymond E. Lord, North Adams, MA (US); John M. Lord, North Adams, MA (US)

(72) Inventors: Raymond E. Lord, North Adams, MA (US); John M. Lord, North Adams, MA (US)

(21) Appl. No.: 14/121,828

(22) Filed: Oct. 22, 2014

Related U.S. Application Data
(60) Provisional application No. 61/967,476, filed on Mar. 20, 2014.

(51) Int. Cl. B24B 3/60; A61C 3/10

(52) U.S. Cl. CPC B24B 3/605; A61C 3/10

(57) ABSTRACT

A small diameter rod of sintered fine-grain and high-purity alumina rotated around its axis against the cutting edge of an instrument provides superior cutting edges with a minimum reduction of the surface of the instrument.

### BACKGROUND

This invention relates to a method for sharpening a cutting edge of a tool or instrument, and more particularly to a method for sharpening a cutting edge and restoring a point on an instrument.

### PRIOR ART

It is known in the art to shape a honing stone composed of alumina and magnesia so as to hand guide a dental curette against the hone for sharpening the curette.

This prior art method is slow and painstaking and results in incomplete sharpening of the curette. Since there are 3 (three) surfaces contributing to the cutting edges of a curette, addressing only 1 (one) of these surfaces results in partial sharpening, with the rotary method of this invention all 3 (three) surfaces are easily and quickly addressed, resulting in complete sharpening.

Further, all other dental instruments requiring sharpening (explorers, spoons, carvers, knives, scissors, etc.) are not included in the prior honing art. All of these instruments are readily and quickly sharpened by the rotary technique described in the invention of this application.

It is further known that abrasive stones will sharpen instruments and tools. However, there are drawbacks to this approach. They are namely:
A) a reduction in size of the instrument or tool that weakens the instrument or tool and shortens its useful life span.
B) there is a residual coarse surface on the instrument or tool, meaning sharpening is incomplete.

### SUMMARY OF THE INVENTION

It is the object of this invention to provide a quick and easy method of complete sharpening of instruments and tools utilizing rotary alumina rods to:
A) obtain complete sharpening of the cutting edges of instruments and tools with a minimum reduction of the surfaces
B) greatly prolong the usable life span of the instrument or tool.
C) obtain smooth, burnished surfaces contributing to the cutting edge. This makes subsequent sharpening quicker, more effective and maintains an effective cutting edge for a longer period of time.

In accordance with this invention, a tubular rod of high purity alumina is rotated against the surfaces contributing to the cutting edge of an instrument or tool. This results in highly sharpened and smooth burnished surfaces with a minimum reduction of instrument and tool. Instrument or tool life is greatly prolonged and successive sharpening is quicker and easier.

Also in accordance with this invention a small diameter rod of sintered fine-grain and high-purity alumina is rotated around its axis against the surface of an instrument to be sharpened.

I begin with tubular rods of high purity alumina. I mount these tubular rods as per FIG. 1 and FIG. 2. It should be noted that the surface is normally smooth to the touch. This surface texture can be made more irregular if a particular sharpening application calls for it.

Tubular rods of about one quarter inch in diameter are suitable for most sharpening operations. However, the diameter can be increased or decreased depending on this particular need.

With power rotation of these mounted tubular rods, the following can be accomplished:
A) a superior, uncomplicated and fast method of sharpening all cutting edges. Further a method of easily restoring a sharp point to pointed instruments or tools.
B) there is a smoothing or burnishing of the surfaces contributing to the cutting edge(s) with a minimum reduction of the surfaces being sharpened. This has 2 (two) favorable results:
   1. Instrument life is dramatically prolonged.
   2. Successive sharpenings provide quicker results with even less instrument reduction.

### BRIEF DESCRIPTION OF THE DRAWING

FIG. 1 shows in expanded view the sharpening device utilized in the method of this invention.

FIG. 2 shows in assembled view the sharpening device of FIG. 1.

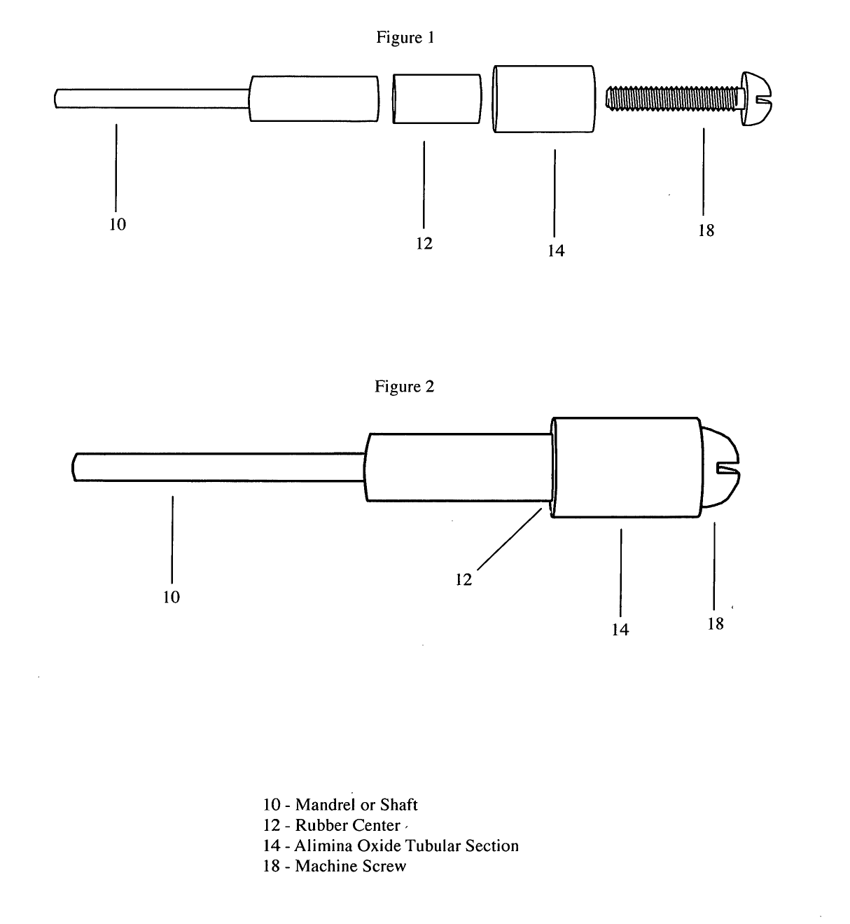

### DESCRIPTION OF THE PREFERRED EMBODIMENTS

The assembly of the drawing includes a tubular rod 14, of sintered pure alumina. Rubber member 12 is inserted in the bore of rod 14. The rubber member 12 is tightened against rod 14 by means of screw 16 thereby securing rod 14 against rotation within holder 10.

The extreme hardness of alumina and the hollow configuration of rod 14 permit attachment of rod 14 to holder 10 by well established squeeze bushing technique. Holder 10 is sized so as to be mounted in the chuck of a hand-held or bench-marked drill or a lathe.

Rod 14 is composed solely of alumina of the finest grain size available in the market. I have discovered that the quarter inch diameter alumina rods that are used as insulation for high intensity lighting can with proper manipulation be utilized to produce a superior cutting edge on a tool.

It has been found in my experimentation that the requirement for proper grit is simply to select a rod that is smooth against bare skin. I have found that alumina insulators used for high intensity lighting are highly effective in the method of my invention.

I claim:

1. A method for sharpening a cutting edge of an instrument with a minimum reduction of the surface of the instrument, said method comprising providing a small diameter rod of fine-grain and high-purity alumina, and rotating said rod against a cutting edge of said instrument.

2. The method of claim 1 wherein the sharpening surface of said rod is smooth against bare skin.

3. The method of claim 1 wherein said rod is about one quarter inch in diameter.

4. The method of claim 1 wherein said rod is rotated against each of the cutting edges of said instrument.
